(19) United States
(12) Patent Application Publication
(10) Pub. No.: US 2004/0259443 A1
(43) Pub. Date: Dec. 23, 2004

(54) Stitchless waterproof insulated products

(76) Inventors: Li Yick Lap, Hong Kong (CN); Darren Li Yick Yin, Hong Kong (CN)

Correspondence Address: Donald J. Ranft, The Holyoke-Manhattan Building, 80 South Highland Ave, Ossining, NY, 10562, US

(21) Appl. No.: 10/761,684

(22) Filed: Jan. 21, 2004

Related U.S. Application Data
(63) Continuation-in-part of application No. 10/465,479, filed on Jun. 19, 2003.

(51) Int. Cl. B32B 27/12; B32B 27/04; B32B 5/26

(52) U.S. Cl. 442/36; 442/35; 442/38

(57) ABSTRACT

This is a new method for the construction of waterproof insulated products, by creating individual insulation-filled compartments without stitching through the outer shell of the product. This invention further provides a method for constructing waterproof insulation products without requiring the attachment of the individual compartments to the inner lining.

### CROSS REFERENCE TO RELATED APPLICATIONS

This Application is a Continuation-in-Part (CIP) of application Ser. No. 10/465,479 filed on Jul. 9, 2003.

### BACKGROUND OF INVENTION

Down

Down is a natural cluster product derived from goose feather. It is generally accepted that down is a very efficient insulation material to be used in insulated products like jacket, comforter and sleeping bag. Down is very lightweight and it also provides exceptional thermal protection value. Both of these properties combine to make down a very popular insulation material in today's market.

The down that we find inside of down-filled product must be previously processed before it is used. The process of transforming goose feather into down cluster necessitates (for sanitary purposes) a series of washing procedures. This series of washing process removes most of the down's naturally inherent oils; hence the final down product (cluster) loses most of its natural moisture resistance. As a result, the down that we use as an insulation material today, although very light, soft and warm, it is vulnerable to moisture and is not suitable for use in damp, cold conditions.

Down is usually graded by its expansion ability. The testing procedure usually involves with putting a batch of down into cylindrical tube with volume measures (cubic inch). The down is then allowed to settle within the tube. The respective volume is marked down and have it divided by the weight of the down batch, the result is then in the unit of cubic inch per ounce. Cubic inch per ounce, in general, is often referred to as Fill Power, which is widely accepted by the industry as a measuring unit for down. The higher the Fill Power is, the better the heat retention is in the down, and thus better the performance is in a product.

Down usually functions very well in preserving heat except in the presence of water. Most of the natural oils has been washed away during the washing process, so a batch of processed down will soak up water very much like a cotton sponge does in real life. This can be a big problem because the down will lose it heat-preserving ability the minute it is in touch with water. Even after the down is dried up later, it will never be able to recover to the same performance level (Fill Power) as in before. So water and down are no friends of each other.

Down-filled Product and Waterproof

Comforters are mostly for use at home, so being waterproof is not typically a concern. However, down jackets and down sleeping bags are both related to outdoor activities where variable weather plays an important role. It is logical to expect that being waterproof is a very desirable feature in down jacket/sleeping bags. Strangely, it seems that there is hardly any waterproof down jacket/sleeping bags in the market today. Most of the down insulated products people will find in the market today are not designed to be used under damp condition due to the down content being so sensitive to moisture. A waterproof jacket in the market today typically contains no insulation material or uses synthetic fiber. By the same token, it is easy to buy a sleeping bag, but it is almost impossible to find a waterproof sleeping bag in the market, let alone a waterproof down sleeping bag. It will be easier to understand why this is the case by looking in detail how a down system is constructed.

Down clusters behave much like fluid in that they need to be contained in a defined volume of space (compartment). A typical down construction is shown in FIG. 1. A compartment space is usually made of fabrics and a material called polytricot. Polytricot is lightweight netting made of polyester. The netting structure is very dense in order to prevent down penetration. However, it offers no insulating value and its function is nothing more than providing a lightweight medium to containing the down in each of the compartments. FIG. 2 shows a typical down jacket and a sleeping bag.

In general, a good down system should consist of a number of small compartments, such that it ensures evenly distributed system coverage. The construction of a down compartment involves the joining of fabric pieces together with polytricot by normal sewing thread (stitching). The problem from a waterproofing perspective is that every stitch to the (shell) fabric surface also creates a needle hole. The more the stitch lines are on the fabric surface, the more needle holes to be found as well. Needle holes are usually very small and not very noticeable; however, each hole potentially causes a major obstacle to waterproofing by allowing water to penetrate through to the down compartments. (FIG. 3) Also sewing thread itself is mostly made up of cotton which tends to soak up water as well.

One common way to solve the needle hole problem is the application of seam taping. The seam taping process generally makes use of a seam-sealing machine to apply seam tapes. Most of the seam tapes available in the market are polymer based thin films. In general the seam tape is melted at a certain condition (temperature/pressure), where it fills into the needle holes on a stitched surface. (FIG. 4) One way to envision the seam tape behavior is compare it to a piece of cheese. At a certain temperature, the cheese will melt. When the temperature is reduced, it will resume a solid physical form.

For a typical seam tape to melt, it is necessary to raise the temperature to at least 120° C. at each application point. However, it is almost impossible to apply this seam taping technique to a down filled product. The application of seam taping process is only applicable on a 2D surface, meaning a seam tape is applied to a flat surface. Down compartment produces volume, which is a three dimensional, not just a surface. Thus as shown in FIG. 5, to apply this process to a down system, every application point needs to be done twice—once on each side of the polytricot stitch point. This would be very costly and time-consuming. The biggest problem, however, is that the polytricot netting that is used to create down compartments cannot endure high temperature. It will melt and break down due to heat. So the use of seam taping in a 3D down compartment is not a solution to create a waterproof down product.

To create a waterproof down product, one has two competing interests to consider. On the one hand, it is important to create a sufficient number of compartments to contain the down. On the other hand, one must also reduce the number of stitches on the fabric surface to avoid creating too many needle holes. Prior to this invention, there does not seem to be any middle ground such that waterproofing and down filling can co-exist. This explains why waterproof down insulated products are rare in the market today.

Waterproofing the outside of a down-filled product does not protect against the absorption of perspiration. The human body has a self-regulated heat management system which generates perspiration when the body gets too hot. Perspiration, or body sweat, consists of salt and water, where both are damaging to down and other insulating materials.

A sleeping bag or garment is designed to help prevent body heat loss to the outer environment. It is important to know that the heat management system in our body is a very dynamic process, where our body is constantly producing heat regardless of how warm/cold the environment is. The key is really how fast/slow such process is in reacting to the environment. It is very common to see that when one is in a sleeping bag/jacket over a long period or time, over night for example, one's body tends to sweat at some point over the course of such time. What really happens is that although the equipment helps setting a stable environment for the user, it can not stop our body from producing heat when the surroundings get too hot. Our body perspiration, most of the time, is soaked up by the lining fabric and thus condenses in the system interior (down). This not only affects the heat preserving ability in the down, the presence of moisture will also facilitate the growth of fungi in the down and thus yields a bad odor over time.

In a normal down insulated equipment, the formation of a filling compartment is a result of stitching together the shell/lining fabric with polytricot. Very often, this stitching is openly exposed and thus creates a problem where normal “wear and tear” may result in breaking these stitches and destroying the integrity of the compartment. The stitchless outer surface eliminates this shortcoming as it yields no open stitches on the outer surface. However, in reality, the “wear and tear” factor is much more vulnerable in the inner surface than in the outer surface. In case of a sleeping bag, campers very often sleep with their full gear (jacket). The in-and-out of sleeping bag actions and frequent body movement all add pressure to the durability of the thread (open stitch). In a normal sleeping bag, there are at least 13 of such open stitches in the lining surface, each covers a distance of at least 58″ in length (around our body in width). The more such equipment is used, the greater the likelihood of breaking of these open stitches.

The invention below is specifically designed to solve these problems.

### BRIEF SUMMARY OF INVENTION

This invention consists of a new technique and method for the construction of insulated products to facilitate being waterproof. This invention provides a means to create the individual down-filled or other insulating material-filled compartments without requiring stitching to the outer shell of the product. This invention further provides a means to create down-filled compartments without stitching to the inner shell and also providing an additional air blanket.

### BRIEF DESCRIPTION OF FIGURES

FIG. 1 is a cross-sectional view of a typical down-filled product.

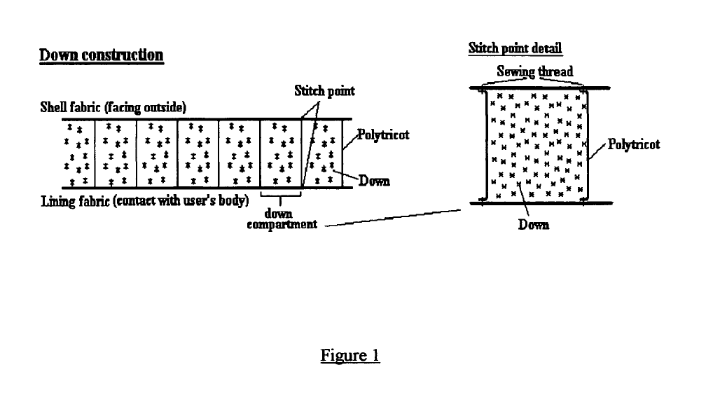

FIG. 2 is a front-view of a down-filled jacket and a top perspective view of a sleeping bag including a cross-sectional view of one compartment for each.

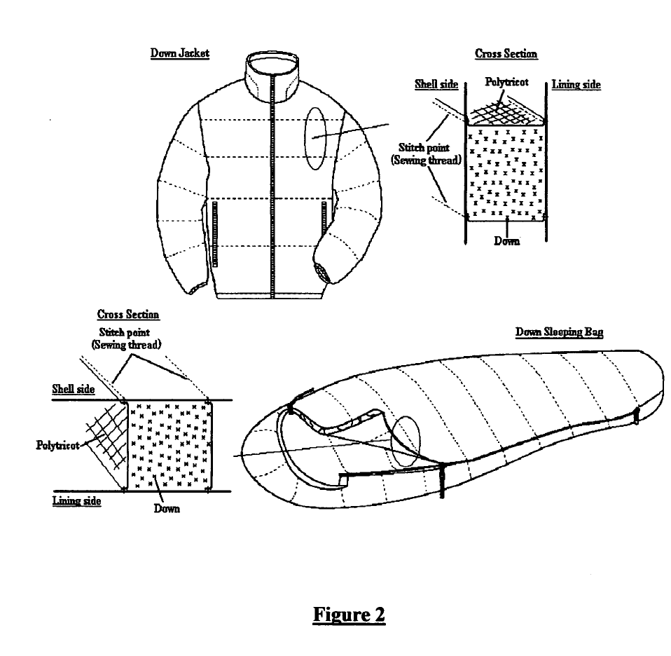

FIG. 3 is a front view of a down-filled sleeping bag and a top perspective view of a sleeping bag including a cross sectional view of one compartment for each. FIG. 3 includes front and side cross-sectional views of a down-filled compartment and a depiction of water landing on the needle holes.

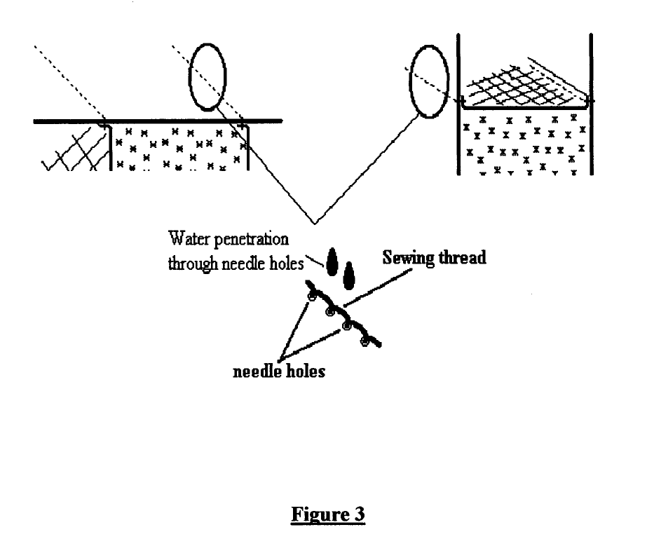

FIG. 4 depicts the application of seam taping to both a topstitching point and an under-stitching point.

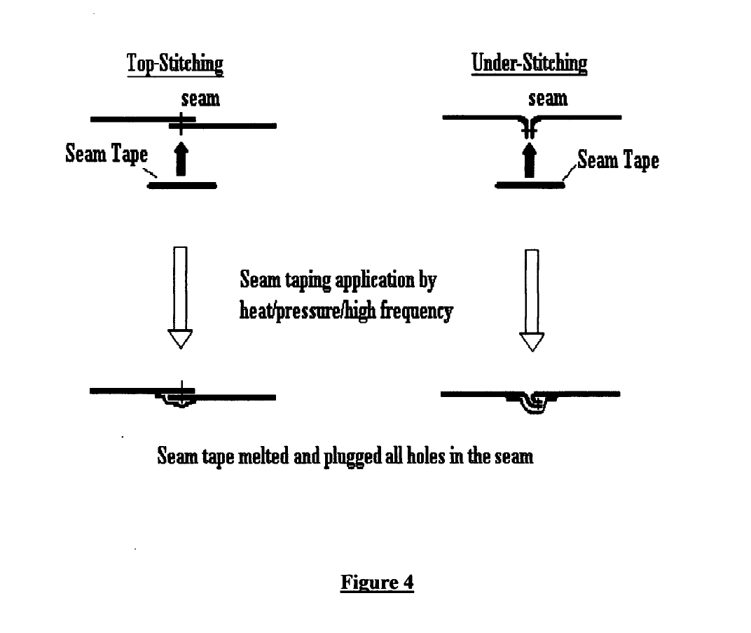

FIG. 5 depicts the required application of seam taping to typical stitch points on the outer shell.

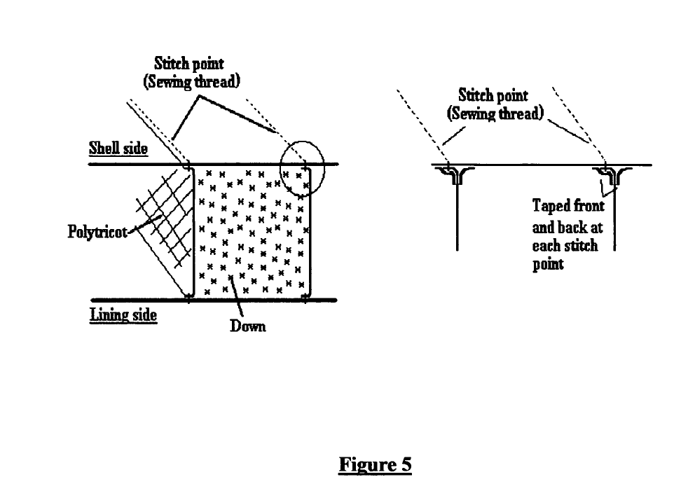

FIG. 6 includes cross sectional views of both a normal down-filled compartment and a compartment with a blown up view of a stitchless attachment point to outer shell.

FIG. 7 includes a front-view of a jacket and a perspective view of a sleeping bag with a cross-sectional view of one compartment for each.

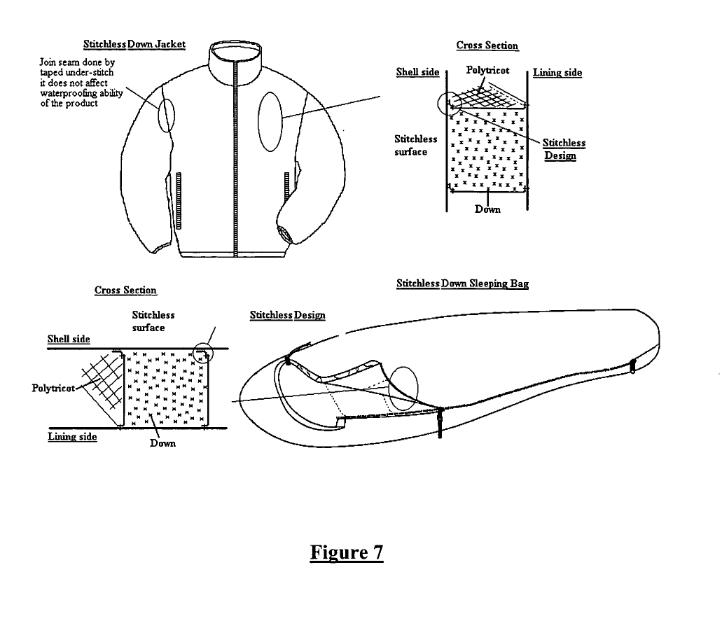

FIG. 8 depicts a front view of a jacket and perspective view of another embodiment of a sleeping bag with a cross-sectional view of one compartment for each depicting the stitchless inner shell and air blanket.

### DESCRIPTION OF PREFERRED EMBODIMENT

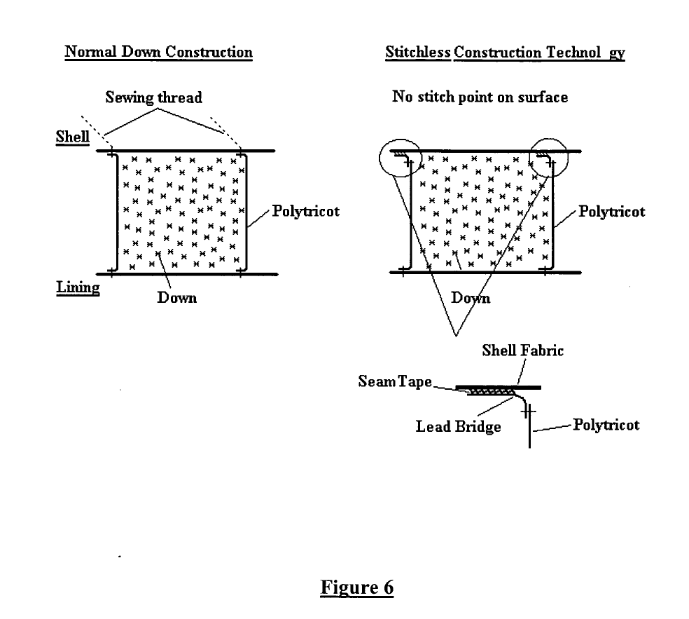

As mentioned above, a good down system needs a good number of compartments. The more the compartments, however, the more stitch holes on the outer shell and thus making waterproofing impossible. This invention specifically addresses this issue since it does not require the use of seam (stitching). FIG. 6 includes a cross-sectional view of the novel design.

The unique feature of this invention is the creation of stitchless blocking (down compartment). A portion of a small strip of fabric (Lead Bridge) is attached to the underside of the outer shell fabric using seam tape or other non-stitching means. The polytricot is stitched to the Lead Bridge to form a down compartment. Because the stitching is done underneath the shell fabric surface, there will not be any stitching in the outer shell surface. The end result is a down system with no stitching penetrating the outer shell surface.

The biggest challenge in creating a waterproof product using existing designs is to be able to plug all possible holes from seam/stitching on the surface. This invention is a new way of construction which eliminates the need for external stitching on the outside surface but enables the creation of down compartments at the same time. By producing a stitch-free environment where there is no stitching hole on the product surface, and thus enables a waterproof design for the product. The main features of this invention design are:

No external stitching (appearance of sewing thread) in the outer surface of a product.

Attachment of Lead Bridges to the underside of the outer shell.

Outer shell fabric and Lead Bridge joined together by seam tape or other non-stitching means.

Netting stitched, or joined by other bonding means, to Lead Bridge on one end and inner lining shell at its other end to form compartments.

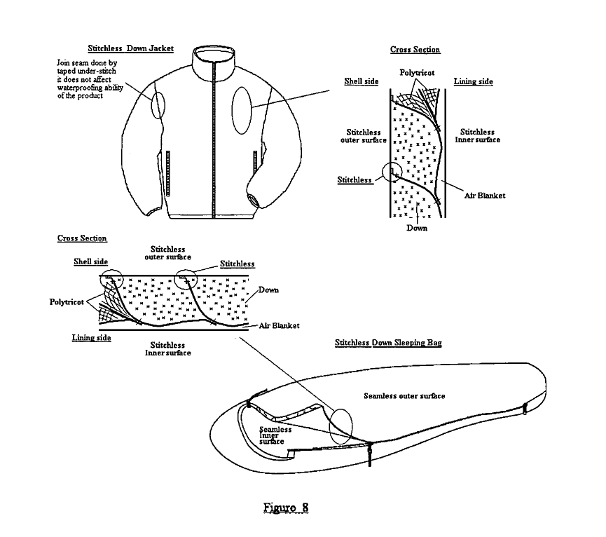

Another embodiment of this invention addresses the problems created by stitching to the inner lining. As shown in FIGS. 8 and 9, in this embodiment the netting or polytricot is not stitched to the inner lining. As depicted in these Figures, the polytricot for this embodiment is stitched to the polytricot of its adjacent compartment. This embodiment provides a true stitchless design on both the outer shell and inner lining. FIGS. 8 and 9 also depict an additional advantage of this embodiment which is the creation of an air blanket between the compartments formed by the netting or polytricot and the inner lining.

The advantages of the air blanket are the additional separation of perspiration from the down-filled compartments and the thermal insulating properties inherent in a captured air space.

The elimination of stitching to the inner lining is the second embodiment significantly reduces the wear and tear caused to the inner lining and enhances the reliability and longevity of the product.

The above description is specifically in relation to the use of this invention for Waterproof Insulated Products for down-filled products such as jackets and sleeping bags. This invention can also be applied in many other applications requiring insulation such as clothing, blankets, piping, buildings, housing, structures, etc. In addition, it can also be applied to other products utilizing materials other than down. This invention is not limited to the specific configurations and methods describe above. For example, other means of bonding the pieces of fabric to the inside of the outer shell may be utilized in lieu of seam tape, and for bonding the polytricot together in the second embodiment in lieu of stitching. For a particular application, it may also be more appropriate to use the second embodiment in relation to the outer shell instead of the inner lining. As with all insulation systems, it can be used to retain heat or cold temperatures as desired.

1. An insulation product comprising:
an outer shell
an inner liner shell
netting attached to either the outer or inner shells to form compartments
insulating material added to the compartments
netting bonded to netting of an adjacent compartment to enclose the insulating material and create an air blanket between the compartments and either the outer or inner shell.

2. An insulating product according to claim 1, wherein the netting is attached to pieces of fabric which are bonded to the inside of either the outer or inner shell.

3. An insulating product according to claim 1, wherein the netting is attached to the outer shell with the air blanket formed between the compartments and the inner shell.

4. An insulating product according to claim 3, wherein the insulating material is down.

5. An insulating product according to claim 3, wherein the insulated product is a sleeping bag.

6. An insulating product according to claim 3, wherein the insulated product is a garment and other clothing.

7. An insulating product according to claim 3, wherein the insulated products is a blanket.

8. An insulating product according to claim 3, wherein the insulated product is used to create insulation for piping, buildings, housing and structures.

9. An insulating product according to claim 3, wherein the outer shell is waterproof.

10. A method for constructing an insulation product comprising:
attaching netting to either an outer or inner lining shell to form compartments;
filling the compartments with and insulating material;
bonding the insulating material in each compartment and creating an air blanket between the compartments and either the outer or inner shell.

11. A method according to claim 10 wherein the netting is attached to pieces of fabric which are bonded to the inside of either the outer of inner shell.

12. A method according to claim 10 wherein the netting is attached to the outer shell with the air blanket formed between the compartments and the inner shell.

13. A method according to claim 12 wherein the insulating material is down.

14. A method according to claim 12 wherein the insulated product is a sleeping bag.

15. A method according to claim 12 wherein the insulated product is a garment and other clothing.

16. A method according to claim 12 wherein the insulated product is a blanket.

17. A method according to claim 12 wherein the insulated product is used to create insulation for piping, buildings, housing and structures.

18. A method according to claim 12 wherein the outer shell is waterproof.
